(19) United States
(12) Patent Application Publication
(10) Pub. No.: US 2009/0050135 A1
(43) Pub. Date: Feb. 26, 2009

(54) ADSORBENT AND METHOD FOR PURIFICATION OF CRUDE SUGAR JUICES

(75) Inventors: Werner Zschau, Steinebach (DE); Rosalina Condemarin, Lima (PE); Jose Antonio Ortiz Niembro, Puebla (MX)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/996,567

(22) PCT Filed: Jul. 25, 2006
(86) PCT No.: PCT/EP06/07337

§ 371 Date: Sep. 16, 2008

(30) Foreign Application Priority Data
Jul. 27, 2005 (EP) 05016334.4

(51) Int. Cl. C13D 3/14; C13D 3/12; B01J 20/12

(52) U.S. Cl. 127/46.2; 127/55; 502/406; 502/402

(57) ABSTRACT

The invention is directed to a process for obtaining white sugar from sugar cane by treating the crude sugar juice with acid activated bentonite selected from the group of smectites, whereby the acid activated bentonite mixture replaces the traditional environmental unfriendly sulfitation process, wherein the mineral bentonite together with aluminium and iron sulfates, phosphoric and sulfuric acid and acid salt solutions allows to obtain a high quality white sugar.

This invention relates to a method for purification of crude sugar juices obtained by extraction of sugar containing plants and an adsorbent which is in particular suited for the purification of crude sugar juice.

Sugar is produced in industrial scale from sugar beets and sugar cane. For extracting the sugar the canes are milled such that the plant cells of the cane are ruptured by pressure to release the sugar-bearing juice. Hot water may be added to the crushed cane to improve extraction of the sugar compounds. For releasing the sugar from sugar beets, the beets are chopped into small pieces that are then cooked with a small amount of water. The crude sugar juice is then released by pressing the mixture through a mill.

The crude sugar juices obtained from sugar cane and sugar beets are similar in composition and, therefore, can be further purified in basically the same way.

The crude sugar juice is turbid and dirty, greenish in colour and acetic. It contains, besides the requested sugar (sucrose), other components which have to be removed during sugar refining. The so called non-sugar components (NS compounds) comprise organic compounds, for example invert sugar, raffinose and ketoses, organic acids, proteins, polypeptides, amino acids, enzymes etc., as well as inorganic compounds, for example salts of potassium, sodium, calcium and magnesium with anions chloride, phosphate, sulfate and nitrate. Phosphates in the crude juice are present in two forms, as inorganic phosphates and as organic phosphates. The origin of the inorganic phosphates is due to addition of fertilizers in the treatment of the cultivation soils. Their concentration in the crude sugar juice is below 0.4 wt.-%. The organic phosphates are contained in the crude juice as gums in an amount of about 0.30-0.60 wt.-% and in the form of other phosphatides in an amount of about 0.03-0.05 wt.-%. Besides the a.m. ions the crude sugar juice contains oxalate, bicarbonate and carbonate ions. The crude juice reacts acidic and the low pH value catalyses the hydrolysis of sucrose, thereby reducing the yield of solid sugar.

For purification the crude juice is first mixed with calcium hydroxide (lime) in order to increase the pH to a value of from about 6.0 to 8.0. The calcium ions introduced react with carbonate ions, oxalate ions and other NS compounds present in the crude sugar juice to form a precipitate. To support precipitation of colloidal components, organic polymers are often added to the crude sugar juice to act as flocculants. These precipitates often form very hard scales/incrustations that adhere quite firmly to the metallic surfaces of the vessels used in the purification of the sugar juice and are hard to remove.

In order to produce white sugar plantation, after or simultaneously with the lime treatment excess calcium hydroxide is precipitated as insoluble CaSO₃ by introducing gaseous SO₂ into the crude juice. This treatment is called sulfitation. The precipitates formed during sulfitation act as crystal germs and as surface for adsorption of other precipitation products. The sulfur dioxide needed for this step is produced in affiliated plants by burning of sulfur. The gaseous effluence formed during burning as well as by release of gases not adsorbed during the sugar juice treatment makes the process environmental unfriendly.

The slurry formed during the sulfitation has to be filtered to separate the purified sugar juice from the precipitated matter. The filter cake contains significant amounts of sugar juice and therefore has to be washed and dehydrated. The dehydrated filter cake may be used as lime fertilizer. For unproblematic use of this lime fertilizer, the moisture content has to be reduced to get a free-flowing powder after milling.

The thin juice obtained after these purification steps is concentrated by evaporation of water. A brown colouring of the thick juice is often observed due to caramelization of the sugar and other reactions. The solid sugar is then recovered from the thick juice by crystallization. A small residual amount of the thick juice, which cannot be crystallized, is used as low-graded liquid sugar.

U.S. Pat. No. 5,262,328 discloses a non-toxic composition for the clarification of crude sugar-containing juices, in particular sugar cane juice, and related products. The purified juice may then be analysed for its sucrose content. The composition consist of A) aluminium chloride hydroxide, B) lime and C) activated bentonite. The bentonite contains calcium aluminium silicate. Preferably the composition also contains a polymeric flocculating agent. Components A) and B) are admixed, one with the other in concentrations sufficient, when added to the crude sugar-bearing juice, to neutralize its acetic character. Component C), in a dry form, is added to the mixture of A) and B). After admixture of components A) and B) to the crude juice the pH of the solution will range from about 6 to about 8, and preferably will be approximately 7. Component C) is a bentonite activated by introducing into the raw bentonite a suitable amount of an activator solution, e.g. a sodium carbonate solution, and then drying the material. Further, an acid activated bentonite may be used wherein a mineral acid, such as hydrochloric acid or sulfuric acid is added to a suspension of the raw clay in water and the mixture is heated to about 100° C. for several hours. The heated mixture is diluted with cold water and washed, for example in a filter press, to remove excess acid almost completely. The activated bentonite is dried to a convenient moisture content, for example 8% to 15% by weight, and then pulverized to suitable size. The acid treatment eliminates alkali metals and calcium and reduces the content of magnesium, iron and aluminium. Further, bentonites, particularly those naturally occurring bentonites which already comprise substitutable bound alkali ions, can be activated by treatment with magnesium salts, e.g. magnesium sulfate, or magnesium salts in combination with alkali salts. The contaminants contained in the crude sugar juice are absorbed on the bentonite containing calcium aluminium silicate. The absorbed contaminants may then be encapsulated by a reaction of the bentonite with the lime. The composition, on addition to the crude cane juice, reacts very quickly by merely shaking or stirring to form a feathery or gelatinous precipitate which is readily separated from the sugar-containing solution by filtration. An optically clear solution with low colour is obtained which can be directly read on a polarimeter to determine the sucrose content.

In DE 197 48 494 A1 is disclosed a method for purification of crude juices obtained in the raffination of sugar. The crude juice is treated with a mixture of calcium hydroxide and a clay material selected from the group of smectites and kaolines, wherein the amount of calcium hydroxide in the mixture is less than about 70 wt %. The clay mineral, residual calcium hydroxide and calcium salts precipitated from the sugar juice are then separated from the purified thin juice. The bentonite used may be activated by acid, e.g. by spraying 3 wt.-% concentrated sulfuric acid on a calcium bentonite. The addition of calcium hydroxide for neutralization of the crude juice may be performed before, together with, or after addition of the (acid activated) bentonite. In one example the raw juice is neutralized by addition of a Ca(OH)₂ solution to give a pH of 8.0. An acid-activated bentonite is added followed by separation of the purified juice from the solid matter. In a further example at first the crude juice is treated with an acid-activated bentonite and the mixture is then neutralized by addition of Ca(OH)₂ solution to adjust a pH of 7. The purified juice is then separated from the solid matter.

It is an objective of this invention to provide an improved method for purification of crude sugar juices obtained by extraction of sugar-containing plants which can be performed in an environmental friendly manner and which allows to perform a rapid and efficient purification of crude sugar juice.

This objective is solved by a method according to claim 1. Preferred embodiments are defined in the depending claims.

According to the invention a method for purification of crude sugar juices obtained by extraction of sugar-containing plants is provided wherein:
a crude sugar juice is provided;
the crude sugar juice is mixed with an adsorbent obtained by activating a clay by depositing on the clay:
   an acid;
   an iron salt;
   and an aluminium salt;
to obtain a mixture;
the pH is adjusted within a range of 6.0 to 8.0 by addition of Ca(OH)₂; and
a purified sugar juice is separated from the mixture.

In the method according to the invention an adsorbent is used which has an exceptionally high adsorption capacity for contaminants of the crude sugar juice due to the high surface of the clay and the ions deposited on its surface.

According to the invention, first a crude sugar juice is provided. The term “crude sugar juice” as used in connection with the method of the invention is to be understood as every sugar juice having a more intense colour or a higher content of contaminants than the purified sugar juice. The crude sugar juice may be obtained directly by extraction from sugar-containing plants. However, the crude sugar may have been purified already but still has an insufficient colour intensity or contains an unacceptable amount of contaminants. The crude sugar juice preferably has a sucrose content of more than 10 g/l, in particular more than 14 g/l, particularly preferred 15 g/l to 50 g/l, most preferred 15 g/l to 20 g/l. The crude sugar juice is preferably obtained from sugar cane.

The crude sugar juice is coloured and contains contaminants to be removed by the method according to the invention. The colour of the crude sugar juice is mainly due to chlorophylls, anthocyanines, polyphenols, rubbers, waxes, phosphatides and other compounds, like acyclic and aromatic anions, which are highly hydrated and of high molecular weight. Most of the coloured contaminants as well as colloids and proteins contained in the crude sugar juice, are of anionic nature. On the adsorbent are deposited cations, in particular protons of the acid, aluminium ions and iron ions. With addition of the adsorbent the cations present on the clay surface may react with the coloured anionic components of the crude sugar juice, e.g. by complex formation, thereby producing insoluble compounds of high molecular weight. Aluminium ions deposited on the clay surface form quite stable complexes with the hydroxide groups of polyphenols and hydroxyketones. Further, polyphenols react with the iron cations (Fe²⁺) present on the activated clay. The contaminants are precipitated on the clay surface and may further react with calcium ions introduced with the Ca(OH)₂-solution. The Ca(OH)₂ preferably is added as an aqueous solution having a concentration of at least 4 g/l, preferably 5-6 g/l. pH-adjustment of the crude sugar juice by addition of calcium hydroxide may be performed before, together with, or after addition of the activated clay.

The adsorbent used in the method according to the invention has a high adsorption capacity and therefore may bind large amounts of contaminants to its surface. The adsorbent acts as a flocculate for fine particles dispersed in the crude sugar juice and therefore those fine particles may be removed by simple filtration or settling. Furthermore, the adsorbent adsorbs excess calcium hydroxide as well as precipitated calcium salts formed during the refinement. The amount of calcium hydroxide added to the crude sugar juice can be decreased in comparison to the known sulfitation process. Further, the addition of the adsorbent improves sedimentation of the precipitate formed during purification of the crude sugar juice such that a turbidity reduction of up to 98% may be achieved. As a further advantage of the method according to the invention, the sedimentation speed increases and therefore the purification of the crude sugar juice requires less time in the clarifying tank.

The precipitate formed may then be separated form the sugar juice by conventional methods, e.g. by filtration, sedimentation or settling. The filter cake may be washed with water to remove sugar juice retained in the filter cake. The filter cake may then be dried and milled to be used as a fertilizer. Advantageously, the filter cake does not contain environmental unfriendly contaminants.

By the method according to the invention the colour intensity of the crude sugar juice can be reduced to about 20 to 25% of the intensity of the crude sugar juice.

According to a preferred embodiment, the adsorbent is obtained by activating the clay by an acid selected from the group of phosphoric acid and sulfuric acid. Other acids may be used as well. But, as the refined sugar is intended for consumption by man, use of sulfuric acid and phosphoric acid does not pose any health problems. The activation may be performed by only using sulphuric acid or phosphoric acid or by using a mixture of sulphuric acid and phosphoric acid.

According to a preferred embodiment, at least part of the acid used for activating the clay is formed by phosphoric acid. The crude sugar juice contains bicarbonate, carbonate and oxalate anions which may react with calcium ions introduced by the addition of Ca(OH)₂ during neutralization of the crude sugar juice to form a precipitate that adheres to the walls of the vessel in the form of hard scales. The adsorbent used in this embodiment contains phosphate anions loosely bound to its surface. The phosphate ions have a higher affiliation for the calcium contained in the juice than the respective bicarbonate, carbonate or oxalate anions and the speed of formation of calcium phosphate (Ca₃(PO₄)₂) is higher than the speed of formation of calcium carbonate and calcium oxalate. Therefore, calcium phosphate is formed instead of calcium oxalate or calcium carbonate and hard incrustations on the walls of the vessels are avoided completely or the amount of their formation may be at least reduced. As a further advantage, the calcium phosphate forms a soft sludgy complex which can be removed easily by agitation or high flow. Scales/incrustations eventually formed on the metallic surface of the vessel therefore can be removed easily.

According to a further embodiment of the method of the invention the pH-adjustment is performed in a stepwise manner. The crude sugar juice is first adjusted to a pH of 5.0 to 7.0, preferably 5.5 to 6.5 by addition of a suitable base, preferably calcium hydroxide. Then, the adsorbent is added followed by adjustment of the pH within a range of 6.0 to 8.0 by addition of Ca(OH)₂. The pH-level in the first alkalization step is lower than in the second alkalization step, i.e. more acidic.

According to a further embodiment of the method according to the invention the adsorbent is obtained by additionally depositing calcium ions on the clay. Calcium ions form precipitates with many organic anions and, therefore, may further improve removal of contaminants from the crude sugar juice.

The adsorbent used in the method according to the invention is obtained by at least depositing an acid, aluminium and iron ions and optionally calcium ions on the surface of a clay. The clay may be a high performance bleaching earth (HPBE). Such HPBE is produced by boiling a clay obtained from a natural source and purified the usual way to remove coarse particles with acid. By boiling the clay with the acid, aluminium ions are extracted from the clay. HPBE have larger pores than natural clays and the pore volume is mainly formed by pores having a pore diameter of about 10 to 100 nm (D₅₀). Such HPBE may be obtained from commercial sources. Besides HPBE natural clays may be used which are activated by acid deposited on their surface. Such clays are designated SMBE (Surface Modified Bleaching Earth). SMBE is preferred in the method according to the invention. The clays for producing the adsorbent, in particular the natural clays used in the embodiment of SMBE, are preferably selected of the group of smectite clay minerals and kaolin grouped minerals. Preferably, bentonite is used as the starting clay. Bentonite mainly comprises montmorillonite. Montmorillonite belongs to the group of smectitic clays and has the formula (Al_{3.2}Mg_{0.8}) (Si₈)O₂₀(OH)₄(CO₃)_{0.8}. Other suitable smectites are hectorite, nontronite, vermiculite and illite.

Because of their ion exchange capacity and due to their large surface area, the smectite clay minerals and kaolin grouped minerals may break the colloids contained in the crude sugar juice and simultaneously adsorb the thereby formed precipitate. The activated bentonite therefore acts in a similar manner as the calcium sulfite in the known sulfitation process.

The clay is activated by depositing on its surface at least an acid, aluminium and iron ions and optionally calcium ions. The activation may be performed by simply mixing the clay with a solution of an appropriate acid, iron salt and aluminium salt. However, the adsorbent may also be obtained by e.g. spraying a solution containing the acid, the iron salt, the aluminium salt and optionally the calcium salt on the clay. Conveniently, an aqueous solution is used to deposit the acid, the iron salt, the aluminium salt and optionally the calcium salt onto the clay. The activated clay may then be dried and milled according to known procedures to obtain the adsorbent. The particle size of the activated clay is preferably selected within a range of 10 to 200 μm (D₅₀).

Based on the weight of the adsorbent the iron salt, calculated as Fe₂O₃, is preferably applied in an amount of 0.1 to 2 wt %, in particular in an amount of 0.2 wt % to 1.0 wt %, most preferred in an amount of 0.4 to 0.7 wt.-%. The amount of aluminium, calculated as Al₂O₃, is preferably selected within a range of 1 to 8 wt.-%, in particular 2 to 6 wt.-%, most preferred 3 to 5 wt.-%. The amount of calcium applied onto the clay, calculated as CaO, is preferably selected within a range of 0.1 to 2 wt.-%, in particular 0.2 to 1.5 wt.-%, most preferred 0.8 to 1.2 wt.-%.

The adsorbent and the crude sugar juice are preferably mixed at a temperature of 10° C. to 50° C., preferably 25° C. to 35° C., in particular preferred at about room temperature.

After mixing the adsorbent and adjusting the pH the mixture is agitated for preferably 10 to 30 minutes.

To improve the clarification of the crude sugar juice, the mixture is preferably heated to a temperature between 80° C. and the boiling point of the mixture. The duration of the heating depends on the colorization degree of the crude sugar juice and the amount of activated clay added to the mixture. Preferably, heating is performed for a period of 5 minutes to 2 hours, in particular 15 to 45 minutes.

For a purification of the crude sugar juice it is not necessary to add large amounts of the adsorbent and therefore losses caused by sugar retained in the filter cake may be minimized. Usually, the amount of adsorbent added to the mixture is selected within a range of 0.05 wt % to 1 wt %, preferably 0.15 to 0.5 wt %, based on the crude sugar juice.

Preferably, clays with a specific surface area of at least 30 m²/g, preferably about 50 to 200 m²/g and a cation exchange capacity of at least 20 meq/100 g, preferably 30 to 100 meq/100 g, are used for the preparation of the adsorbent. After activation the specific surface of the clay is reduced by about 3 to 8%.

The adsorbent used in the process according to the invention removes contaminants contained in the crude sugar juice quite efficiently. A further treatment of the mixture with SO₂ or CO₂ as in the methods according to the state of the art therefore is not necessary to remove excess calcium ions used for pH-adjustment. In a preferred embodiment the method according to the invention does not comprise any SO₂-treatment or CO₂-treatment of the crude sugar juice or of the mixture obtained by addition of the adsorbent to the crude sugar juice and adjustment of the pH by addition of calcium hydroxide. The adsorbent does not contain any hazardous components and therefore may be handled by the workers without difficulties. Further, no hazardous waste is produced by the process. The filter cake may be used as a fertilizer such that no problems as to deposition occur.

The invention is further directed to an adsorbent that is in particular suited for purification of crude sugar juices. The adsorbent is comprising a clay, water extractable iron ions and aluminium ions, wherein a suspension of 25 g of the adsorbent in 250 ml distilled water has a pH within a range of 1 to 3, preferably 1.5 to 2. The amount of water extractable iron ions, calculated as Fe₂O₃, is preferably within a range of 0.1 to 2 wt.-%, in particular 0.2 to 1 wt.-%, and most preferred 0.4 to 0.7 wt.-%. The amount of water extractable aluminium ions, calculated as Al₂O₃, is preferably within a range of 1 to 8 wt.-%, in particular 2 to 6 wt.-%, and most preferred 3 to 5 wt.-%.

According to a preferred embodiment the adsorbent comprises water extractable phosphate ions. The amount of phosphate ions, calculated as H₃PO₄, is preferably within a range of 1 to 10 wt.-%, in particular 2 to 8 wt.-%, most preferred 2.5 to 5 wt.-%.

According to a still further preferred embodiment the adsorbent comprises water extractable calcium ions. The amount of calcium ions, calculated as CaO, is preferably within arrange of 0.1 to 2.0 wt.-%, in particular 0.2 to 1.5 wt.-%, most preferred 0.8 to 1.2 wt.-%.

The following non-limiting examples and comparative data further illustrate the method of this invention for the clarification of sugar bearing juices.

### METHODS

### Specific Surface Area:

The specific surface area was determined by the BET-method with nitrogen with the single point method according to DIN 61131.

### Ion Exchange Capacity

The ion exchange capacity was determined according to the following method:

The dried clay was heated under reflux with excess aqueous NH₄Cl. The mixture was then cooled to room temperature and settled for 16 hours. The solid material was separated by filtration and the filter cake was washed with water, dried and milled. The NH₄-content in the clay mineral was determined according to Kjeldahl.

### pH Value:

25 g of the sample are suspended in 250 ml of distilled water and the suspension is boiled for 5 minutes. The resulting suspension is filtered and the filtrate is cooled to room temperature. The pH-value is determined by a pH-electrode.

### Bulk Density

A graduated cylinder which has been cut at the 1.000 ml mark is weighed to give wₜₐᵣₐ. Then the sample is filled into the cylinder with the help of a powder funnel such that a cone is formed on top of the cylinder. The cone is removed with the help of a ruler and sample adhering to the outside of the cylinder is removed. The cylinder is then weighed again to give w_{brutto}. The bulk density is calculated as d_{bulk}=W_{brutto}−Wₜₐᵣₐ.

### Moisture Content

About 500 g of the sample to be analysed are given into a weighed glass dish and the dish is put into a drying oven adjusted to 110° C. After 2 hours the glass dish is transferred into an exsiccator and cooled to room temperature. The moisture content is calculated according to the following formula

$$M = \frac{{m}_{0} - {m}_{d}}{{m}_{0}} \cdot 100$$

where
M=moisture content;
m₀=initial mass of the sample
m_{d}=mass of the sample after drying.

### Colour Density:

The colour density of the sugar juices was measured according to ICUMSA method GS 1-7 (1994).

### Sedimentation Speed and Silt Height on 20 Minutes:

The sedimentation speed was determined according to the following method:

In a 500 ml beaker are introduced 400 g of crude sugar juice and the pH of the juice is determined with a pH-electrode. Then 0.6-0.8 g of the adsorbent are added and the mixture is stirred for 5 minutes. By dropwise adding lime suspension the pH-level is adjusted between 7 and 7.3. The alkalinized sugar juice is heated to 100° C. and then 5 ppm of the flocculent (Quemiflock AH 1000, Quemi SAS, Italy) are added with vigorous stirring. 100 ml of the hot sugar juice are transferred into a graduated test tube which is held at a constant temperature of 90° C. The initial level of the sedimentation corresponds to the filling height of the sugar juice in the graduated test tube. When the sugar juice starts to coagulate and flocculate shows, the sedimentation starts. Every minute the level of the phase border between the turbid mud phase and the clear sugar juice is noted until approaching 20 minutes. The height of the mud phase at the reading of 20 minutes corresponds to the silt height after 20 minutes. The sedimentation speed is calculated according to the following formula:

$${V}_{s} = \frac{{h}_{i} - {h}_{20 min}}{20 min}$$

### Where:

Vₛ=sedimentation speed;
hᵢ=height of the sugar juice in the graduated test tube;
h_{20 min}=silt height after 20 minutes.

### Bright Juice Turbidity:

The bright juice turbidity was determined according to the following method:

A 5 cm diameter Buchner funnel is covered with a filter paper and covered with 2.0 g of kieselguhr. The crude sugar juice is diluted to a sugar content of approximately 5 to 8 g/l. About 100 ml of the diluted sugar juice is filtered through the funnel with the first few ml being dropped away. The absorbance A_{f} of the filtrate is measured at 420 nm with a barrel of 1 cm in a spectrometer against a target of distilled water. The absorbance A₀ of the diluted but not filtered sugar juice is also determined at 420 nm with a barrel of 1 cm against a target of distilled water. The turbidity index TI is calculated according to the following formula:

$$T I = \frac{{A}_{0} - {A}_{f}}{D} \cdot 1000$$

### Where

A₀=Original sugar cane juice absorbance
A_{f}=filtered sugar cane juice absorbance
TI=turbidity index
D=dilution factor=sugar concentration in the raw juice/sugar concentration in the sample

### Amount of Water Extractable Anions:

Into a 2.000 ml glass flask are weighed in about 100 g of the test sample and then 1.000 ml of distilled water are added. The suspension is shaken gently for 24 hours at room temperature. Then, the suspension is filtered and the filtrate collected. The concentration of the individual anions is determined by AAS.

### Amount of Water Extractable Phosphate

The amount of phosphate is determined according to DIN 38414, part 12.

### EXAMPLE 1

### Preparation of the Adsorbent

800 kg of a Clay (Mercedes clay, Sud-Chemie Peru, Lima, Peru) were given into a rotating drum and then 2.0 kg of H₃PO₄ (96%) and 12 kg H₂SO₄ (conc.) were sprayed onto the clay. Then, a solution of 1.15 kg Fe₂SO₄ and 11.6 kg Al₂(SO₄)₃ in 50 l of distilled water were sprayed on the clay. Finally, a solution of 0.2 kg CaCl₂ in 5 l of distilled water was sprayed onto the clay. The adsorbent was dried by continuously introducing hot air (90° C.) into the drum. The dried adsorbent was then milled in a plug mill to give an adsorbent having the properties summarized in table 1:

TABLE 1
features of the adsorbent:

| moisture content | Residual on 65 μm | | Bulk density |
|---|---|---|---|
| (%) | sieve (%) | pH | (g/l) |
| 11.3% | 9.3 | 1.9 | 750 |

### EXAMPLE 2

In order to study the influence of the pH of the alkalisation, the clarifier agent and the flocculants dose, a complete factorial experimental design was carried out starting from a sample of blended juice taken in the factory.

The following parameters were determined for every sample:
sedimentation speed;
silt height on 20 minutes;
colour; and
bright juice turbidity.

The experiments were done at two pH levels, two different amounts of acid active bentonite mixture added and two different flocculant doses. The values used for the different levels (“inferior level” and “superior level”) are summarized in table 2.

TABLE 2

| Factors | | Inferior Level (−) | | Superior Level (+) | |
|---|---|---|---|---|---|
| pH | (X₁) | 7.3 ± 0.1 | | 7.9 ± 0.1 | |
| Adsorbent of example 1 | (X₂) | 0.15 | wt.-% | 0.20 | wt.-% |
| Flocculant | (X₃) | 2.5 | ppm | 5 | ppm |

The flocculant used was Quemiflock AH 1000 of Quemi SAS (Italy) and is a polyacrylamide of high molecular weight.

1000 ml of a crude sugar juice where adjusted to the respective pH-level by dropwise addition of Ca(OH)₂ (0.4%). Then the flocculate and the adsorbent were added with vigorous stirring. The mixture was heated to 80 to 100° C. for 30 min. A sample of the hot sugar juice was taken to determine the sedimentation speed and silt height. The mixture was settled for 2 hours. Then, samples were taken from the supernatant to determine colour and turbidity.

Each experiment was done two times. The averaged values measured are summarized in table 3.

TABLE 3

| | | | | | | Speed | |
|---|---|---|---|---|---|---|---|
| | | | | Colour | | Sed. | H. Sed. |
| Run | X₁ | X₂ | X₃ | (ICU) | Turb. | (cm/min) | (cm) |
| 1 | − | − | − | 71.5 | 50 | 2.97 | 5.95 |
| 2 | + | − | − | 70 | 48 | 2.75 | 6.50 |
| 3 | − | + | − | 92.5 | 30 | 2.90 | 5.50 |
| 4 | + | + | − | 84 | 27 | 1.43 | 6.40 |
| 5 | − | − | + | 68 | 14 | 3.17 | 5.70 |
| 6 | + | − | + | 68.5 | 31 | 3.14 | 6.05 |
| 7 | − | + | + | 85 | 30 | 3.10 | 5.75 |
| 8 | + | + | + | 79.5 | 36 | 2.56 | 6.75 |

Table 3 shows that the 7^{th} run offers the best results as for:

Colour: 85 ICU; the purified sugar juice shows a low degree of colouration; the filter sample is clear;

Turbidity: 30 units; at first sight particles in suspension are not observed in the filtered sample;

Speed of sedimentation: 3.1 cm/min; a fast sedimentation of the particles is observed with a good and quick clotting and flocculation;

Height of the silt on 20 minutes of the sedimentation start: 5.75 cm. Big and dense floccules form that allow a good compaction of the silt.

### EXAMPLE 3

### Decolourisation and Subsequent Neutralisation

For these tests, a crude sugar juice was obtained from a Peruvian sugar cane which was burned, washed and crushed by pressing in a mill. The samples were taken in the production line of a factory on three consecutive days each.

To the samples of crude sugar juice having a pH level of approximately 5.2 and a sucrose content of approximately 14 wt % was added 0.15 (M−1)/0.20 wt % (M−2) of the adsorbent obtained in example 1. The mixture was agitated for 5 minutes. Then, the mixture was neutralized to a pH value of 7.3 by addition of a Ca(OH)₂ solution with agitation at room temperature. Subsequently, the mixture was heated to a temperature of 100° C. for 30 minutes. The mixture was settled for 2 hours. Turbidity and colour were determined on a sample taken from the clear supernatant. The absorbency of the filtered solution is measured at a wavelength of 420 nm and the ICUMSA colour of the solution is calculated.

As comparison a sample of the same sugar juice, however purified by the sulfitation method, was analysed. For calculating the colour reduction the sample purified by the sulfitation method was taken as 0% (benchmark).

The results are summarized in table 4.

TABLE 4

| | | | | colour |
|---|---|---|---|---|
| | ICUMSA | | pH | reduction |
| | colour | % abs | value | (%) |
| Raw sugar solution | | | 5.2 | |
| non treated | | | | |
| M-1-1, 0.15 wt % | 7450 | 0.43 | 5.9 | 19.89 |
| M-1-2, 0.15 wt % | 6998 | 0.39 | 5.8 | 24.75 |
| M-1-3, 0.15 wt % | 6781 | 0.41 | 5.7 | 27.08 |
| M-2-1, 0.20 wt % | 6408 | 0.37 | 6.0 | 31.09 |
| M-2-2, 0.20 wt % | 6171 | 0.38 | 6.1 | 33.64 |
| M-2-3, 0.20 wt % | 5780 | 0.35 | 6.1 | 37.85 |
| sulfitated clarified | 9300 | 0.40 | 6.3 | 0 |
| juice, 0.016 wt % | | | | |

The samples purified by the method according to the invention show a lower ICUMSA number when compared to the ICUMSA number of a sample treated by the classical sulfitation process. Lower ICUMSA numbers correspond to a less intense colour of the sample.

### EXAMPLE 4

### Decolourisation and Neutralization by Steps

For these tests, a sugar cane from Peru was used. The crude sugar juice was obtained from sugar cane which was burned, washed and crushed by pressing in a mill. Also, two neutralization ways were employed for these tests.

### a) Direct Neutralization

To 200 g of the crude sugar juice with a pH value of 5.4 and a sucrose content of approx. 14 wt % was added 0.15 wt % (M−1)/0.20 wt % (M−2) of the adsorbent obtained in example 1. The mixture was agitated at room temperature for 5 minutes and then was neutralized to a pH value of 7.3 by addition of a 5.6 wt.-% Ca(OH)₂ solution. Subsequently, the mixture was heated to 100° C. for 30 minutes and then settled for 2 hours.

### b) Neutralisation by Steps

Crude sugar juice with a pH level of 5.1 and a sucrose content of approx. 15 wt % was adjusted to a pH-level of 6.8 by dropwise addition of a 5.6 wt.-% Ca(OH)₂ solution with stirring at room temperature. Then, 0.15 wt % (M−1)/0.20 wt % (M−2) of the adsorbent obtained in example 1 were added with stirring. Subsequently, the pH-level of the samples was adjusted to 7.2 by adding more 5.6 wt.-% Ca(OH)₂ solution. The mixture was heated to 100° C. for 30 minutes and then settled for 2 hours. Samples were taken from the clear supernatant. The absorbency of the filtered solution was measured at a wavelength of 420 nm and the ICUMSA colour of the solution is calculated.

For comparison, a sample obtained by purification according to the sulfitation process was analysed. The ICUMSA colour of this sample was defined as being 0% (benchmark).

The results are summarized in table 5.

TABLE 5

| | ICUMSA | | pH | % red. |
|---|---|---|---|---|
| | color | % abs | value | color |
| Direct neutralization | | | | |
| M-1, 0.15% | 7574 | 0.417 | 6.5 | 9.1 |
| M-2, 0.20% | 6932 | 0.396 | 6.2 | 16.8 |
| Neutralization by steps | | | | |
| M-1, 0.15% | 5776 | 0.318 | 6.4 | 30.7 |
| M-2, 0.20% | 4905 | 0.268 | 6.3 | 41.1 |
| sulfitated clarified juice | 8332 | 0.476 | 6.7 | 0 |

With both neutralization methods a purified sugar juice was obtained that was brighter in colour than the sugar juice purified by the sulfitation method. An even better reduction in colour was obtained for the process using a neutralization by steps.

### EXAMPLE 5

### Decolourisation and Direct Neutralization

For these tests, a sugar cane from Bolivia was used. The crude sugar juice was obtained from sugar cane which was mechanically cut, washed and crushed by pressing in a mill.

To the crude sugar juice having a pH level of 5.4 and a sucrose content of approx. 14 wt % was added 0.15 wt % (M−1)/0.20 wt % (M−2) of adsorbent obtained in example 1. The mixture was agitated for 5 minutes. Then, the mixture was neutralized at room temperature to a pH value of 7.3 by dropwise addition of a 5.6 wt.-% Ca(OH)₂ solution with vigorous stirring. Subsequently, the mixture was heated to 100° C. for 30 minutes. The mixture was settled for 2 hours and samples were taken from the clear supernatant.

For comparison a sample purified by the sulfitation method was analysed. The ICUMSA colour of this sample was defined as 0% (benchmark).

The results are summarized in table 6.

TABLE 6

| | | | pH | % red. |
|---|---|---|---|---|
| | Colorimeter | abs | value | colour |
| M1 - 0.15% | 8172 | 1225 | 6.3 | 14.5 |
| M2 - 0.20% | 7401 | 1293 | 6.2 | 22.50 |
| sulfitated clarified juice | 9556 | 1680 | 6.0 | 0.00 |

Independently from the sugar cane variety a reduction of the ICUMSA colour may be obtained with the method of the invention.

### EXAMPLE 6

### Decolourisation with Subsequent Neutralization and Clarification

### First Industrial Scale Trials in a Peruvian Middle Plant

For this industrial trial, the crude sugar juice was obtained from a Peruvian sugar cane which was burned, washed and crushed by pressing in a mill.

Crude sugar juice with a pH value of 5.4 and a sucrose content of approx. 16 wt % was treated by addition of 0.20 wt % of an adsorbent as obtained in example 1. The crude sugar juice and the adsorbent were mixed for 5 minutes with stirring at room temperature. Then, the mixture was neutralized at room temperature to a pH value of 7.3 by adding a 5.6 wt.-% Ca(OH)₂ solution while continuing stirring. Subsequently, the mixture was heated to a temperature of 100° C. for 30 minutes. After cooling to room temperature and settling samples were taken out of the production line and analysed for ICUMSA colour and turbidity.

The plant trials started at 7:00 of the first day until 8:00 of the next day.

Samples were taken at the times indicated in table 7. In the first hours of the first day sugar juice was analysed that has still been purified by the sulfitation method. Starting at about 12:00 sugar juice obtained by purification with the adsorbent of example 1 was obtained. From about 16:30 on samples were obtained that were purified by the adsorbent of example 1 only. The colour intensity of the sample taken at 7:00 of the first day, which has been purified only by the sulfitation method, was taken as 0% (benchmark).

The results are summarized in table 7.

TABLE 7
Sugar cane juice clarified

| | | % Red. | | % Red. tur- |
|---|---|---|---|---|
| Hour | Colour | colour | Turbidity | bidity |
| 07:00 | 10252 | 0 | 5943 | 0 |
| 09:00 | 10126 | 1.2 | 3982 | 33 |
| 10:30 | 10018 | 2.3 | 2652 | 55.4 |
| 12:00 | 9482 | 705 | 3076 | 48.2 |
| 13:30 | 9430 | 8.1 | 1134 | 80.9 |
| 15:00 | 8333 | 18.7 | 1254 | 78.8 |
| 16:30 | 8070 | 21.2 | 971 | 83.7 |
| 18:00 | 7895 | 23.0 | 1194 | 80 |
| 19:30 | 7522 | 26.6 | 757 | 87.3 |
| 21:00 | 6893 | 32.8 | 821 | 86.2 |
| 22:30 | 7890 | 23.1 | 988 | 83.4 |
| 02:00 | 7962 | 22.3 | 892 | 85 |
| 04:00 | 8166 | 20.3 | 973 | 83.6 |
| 06:00 | 7820 | 23.7 | 842 | 85.8 |
| 07:00 | 8318 | 18.9 | 852 | 85.7 |
| 08:00 | 7340 | 28.4 | 1546 | 73.9 |

The plant trials results proved that it is possible to replace the sulfitation by using an adsorbent as obtained in example 1. A significant reduction in colour intensity as well as in turbidity was achieved by the use of the adsorbent of example 1.

### EXAMPLE 7

### Acid Activated Bentonite Sugar Elaboration

### Second Industrial Scale Trials in a Peruvian Middle Plant

For this industrial trial, the crude sugar juice was obtained from a Peruvian sugar cane of a variety different from the one of example 6. The sugar cane was burned, washed and crushed by pressing in a mill.

Crude sugar juice with a pH value of 5.4 and a sucrose content of approx. 16 wt % was treated by addition of 0.20 wt % of the adsorbent obtained in example 1. The mixture was agitated for 5 minutes. Then, 5.6 wt.-% Ca(OH)₂ solution was added at room temperature to adjust the pH-value of the mixture to 7.3 while continuing agitation. Subsequently, the mixture was heated to 100° C. for 30 minutes. After cooling to room temperature and settling, samples were taken from the sugar juice and analysed for ICUMSA colour and turbidity.

Then, the juice was evaporated until a sugar concentration of about 65% using a crystallization cooking system and crystallization was initialized by seeding in order to obtain plantation white sugar.

The plant trials were made for 11 consecutive days where 22 580 MT sugar cane were milled and 2565 MT white sugar were obtained.

The averaged results are summarized in table 8.

TABLE 8

| Sulfitation Process | | | | | Acid Activated bentonite | | | | |
|---|---|---|---|---|---|---|---|---|---|
| Clarified Juice | | Syrup | | Sugar | Clarified Juice | | Syrup | | Sugar |
| ICUMSA | | ICUMSA | | ICUMSA | ICUMSA | | ICUMSA | | ICUMSA |
| Colour | Turbidity | Colour | Turbidity | Colour | Colour | Turbidity | Colour | Turbidity | Colour |
| 6121 | 2005 | 6332 | 3166 | 282 | 8656 | 1624 | 7492 | 1583 | 283 |
| 7598 | 739 | 8970 | 3588 | 270 | 7070 | 138 | 6964 | 106 | 295 |
| 8231 | 2322 | 8442 | 2110 | 300 | 5500 | 1130 | 6331 | 300 | 292 |
| 7387 | 1899 | 7703 | 1795 | 280 | 4952 | 287 | 5921 | 622 | 299 |
| 8970 | 3482 | 8759 | 3693 | 310 | 4942 | 698 | 7176 | | 292 |
| 6964 | 950 | 8653 | 3272 | 299 | 5521 | 293 | | | 274 |
| 8442 | 1266 | 7809 | 2638 | 237 | 6736 | 288 | | | 361 |
| 7703 | 3500 | 8442 | 4221 | 281 | 5664 | 464 | | | 365 |
| 6754 | 1055 | 7176 | 2849 | 234 | 5062 | 345 | | | 217 |
| 8020 | 1478 | 8337 | 2744 | 218 | 6563 | 479 | | | 157 |
| 8231 | 2322 | 7915 | 3693 | 204 | 5132 | 988 | | | 173 |
| 7387 | 3166 | 7704 | 2849 | 288 | 6735 | | | | 115 |

In table 8 are compared the values obtained by the sulfitation process and the purification using an adsorbent obtained as described in example 1. Clarified juice corresponds to the sugar juice after settling. Syrup corresponds to the sugar juice remaining after separation of the sugar crystals.

The results show, that the final plantation white sugar colour obtained by using the adsorbent of example 1 is lower and better when compared to the sulfitation process.

1. Method for purification of crude sugar juices obtained by extraction of sugar containing plants comprising:
providing a crude sugar juice;
preparing a mixture by mixing the crude sugar juice with an adsorbent obtained by activating a clay by depositing on the clay:
an acid;
an iron salt; and
an aluminium salt;
adjusting the pH of the mixture within a range of 6.0 to 8.0 by addition of Ca(OH)₂; and
separating a purified sugar juice from the mixture.

2. Method according to claim 1, wherein the clay is activated by an acid selected from the group consisting of phosphoric acid and sulfuric acid.

3. Method according to claim 1, wherein at least part of the acid used for activating the clay comprises phosphoric acid.

4. Method according to claim 1, wherein the adjustment of the pH of the crude sugar juice is performed in a stepwise manner by first adjusting the pH of the crude sugar juice within a range of 5 to 7, then adding the adsorbent, and, after addition of the adsorbent, adjusting the pH of the crude sugar juice within a range of 6.0 to 8.0.

5. Method according to claim 1, wherein the clay is further activated by depositing thereon a calcium salt.

6. Process according to claim 1, wherein the adsorbent comprises a high performance bleaching earth.

7. Method according to claim 1, wherein after adjusting the pH, the mixture is heated to a temperature within a range of 80° C. to the boiling point of the mixture.

8. Method according to claim 7, wherein the mixture is heated for a time period of 5 minutes to 2 hours.

9. Method according to claim 1, wherein the amount of adsorbent added to the mixture is within a range of 0.1 wt % to 1 wt %, based on the crude sugar juice.

10. Method according to claim 1, wherein the clay has a specific surface area of at least 30 m²/g.

11. Method according to claim 1, wherein the activated clay has a cation exchange capacity of at least 20 meq/100 g.

12. Method according to claim 1, wherein the clay is selected from the group of smectitic clays.

13. Method according to claim 1, wherein the sugar containing plant is a sugar cane.

14. Method according to claim 1, wherein a sulfitation or carbonation step is not utilized.

15. Adsorbent comprising a clay onto which is deposited an acid, an iron salt and an aluminium salt, said adsorbent comprising water extractable iron ions, calculated as Fe₂O₃ in an amount of 0.1 to 2 wt. % and aluminium ions, calculated as Al₂O₃ in an amount of 1 to 8 wt. %, wherein a 10% (w/w) suspension of the adsorbent in water has a pH within a range of 1 to 3.

16. Adsorbent according to claim 15, further comprising water extractable phosphate ions.

17. Adsorbent according to claim 15, further comprising water extractable calcium ions.

18. Adsorbent according to claim 15, further comprising a polyacrylamide of high molecular weight.
